(19) United States
(12) Patent Application Publication
(10) Pub. No.: US 2011/0296333 A1
(43) Pub. Date: Dec. 1, 2011

(54) User interaction gestures with virtual keyboard

(76) Inventors: Steven S. Bateman, Portland, OR (US); John J. Valavi, Hillsboro, OR (US); Peter S. Adamson, Portland, OR (US)

(21) Appl. No.: 12/800,869

(22) Filed: May 25, 2010

(51) Int. Cl. G06F 3/041; G06F 3/048; G06F 3/033

(52) U.S. Cl. 715/773; 345/173; 715/863

(57) ABSTRACT

A method and device are described that provides for operating system independent gestures and a virtual keyboard in a dual screen device.

### BACKGROUND

Typical touch screen user interfaces are performed with finger gestures. Such finger gestures resolve to a single point on the touch screen user interfaces. Regardless of the shape that is applied to the touch screen user interfaces, the finger gesture or touch point is resolved to a single point. Therefore, touch gestures performed on the touch screen user interface are limited to points. Being limited to points, such finger gestures may have to be precise in order for the touch screen interface to understand the touch command or instruction.

User gestures may be tied to a particular operating system or OS running on a device. In such cases where a dual screen touch panel device may be implemented, there may not be provisions for gestures that would easily move applications or windows from one screen to the other. For example, in a dual screen laptop that implements a virtual keyboard, the virtual keyboard may be called up and appear on one of the screens. Before the virtual keyboard is called up, one or more applications or windows may be present on that screen. The applications may totally go away or be covered up. There may not be OS provided gestures available to specifically move the applications or windows. In addition, gestures provided by the OS may not address (re)presenting applications or windows when the virtual keyboard goes away.

Virtual keyboards for dual screen devices may also have shortcomings. Certain virtual keyboards may be popup windows that appear as soon as an editable field obtains focus. Therefore, the virtual keyboard then gets in the way, if a user only desires to view content. This may require the user to manually position the virtual keyboard after the virtual keyboard appears. Such virtual keyboards may run as a predefined application. There may not be a particular touch gesture that calls up and closes the virtual keyboard application. Furthermore, the virtual keyboard may not be properly centered for use by an individual. In other words, a single “one size fits all” keyboard may be provided. In addition, since virtual keyboards are smooth, there may not be any tactile aides to assist touch typists to properly recognize key positions.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is an illustrative dual screen device and virtual keyboard.

FIG. 2 is a block diagram of an exemplary device that implements gesture recognition.

FIG. 3 is a flow chart for a process of determining a gesture.

FIGS. 4A and 4B are illustrative exemplary hand touch gestures.

FIG. 5 is an illustrative dual screen device with a virtual keyboard and tactile aids.

FIG. 6 is an illustrative dual screen device that calls up multiple windows/applications and a virtual keyboard.

FIG. 7 is a flow chart for a process of calling up a virtual keyboard and positioning of active windows.

### DETAILED DESCRIPTION

### Overview

Embodiments provide for an enhance usability of a dual screen touch panel device using gestures, which can be customized, specific to a usage model for the device, and independent of the operating system (OS) running on the device. Certain embodiments provide for gestures that allow for moving an application window from one screen to another. Using touch data that may be ignored by the OS, custom gestures can be added to the device to enhance user experience without affecting the default user interaction with the OS.

In certain implementations, the dual screen touch panel device, such as a laptop, can have the virtual keyboard hidden when additional screen space is desired by the user. Because a typical OS may usually have keyboard shortcuts for common tasks, additional gestures may be needed when the virtual keyboard is used. Furthermore, additional gestures can be added without changes to built-in OS gestures and can allow for user defined custom gestures that can be added dynamically to a gesture recognition engine. This allows for gestures to be added or subtracted, without having to update the OS. In other words, the gestures are OS independent.

### Dual Screen Device

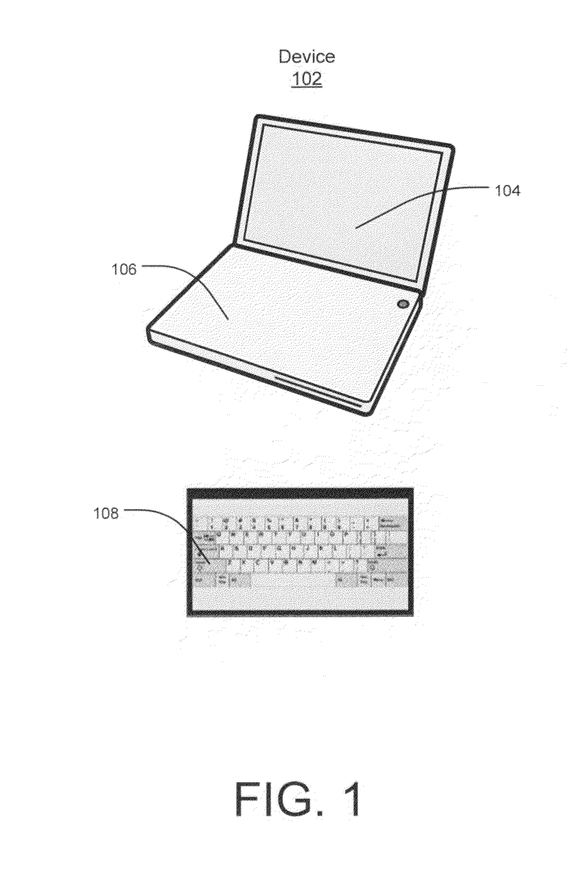

FIG. 1 shows a dual screen touch panel device (device) 102. The device 102 may be a laptop computer or other device. Device 102 includes two touch panel surfaces: a top touch panel surface or B surface 104, and a bottom touch panel surface or C surface 106. In certain implementations, surfaces 104 and 106 provide input control for users, and provide display windows or applications. Unlike devices such as traditional laptop computers, a physical keyboard device is not provided; however, in certain implementations, it is desirable to implement a keyboard for user input. Device 102 provides for a virtual keyboard 108 to be called up. As discussed further below, the virtual keyboard 108 may be called up and go away by implementing various gestures.

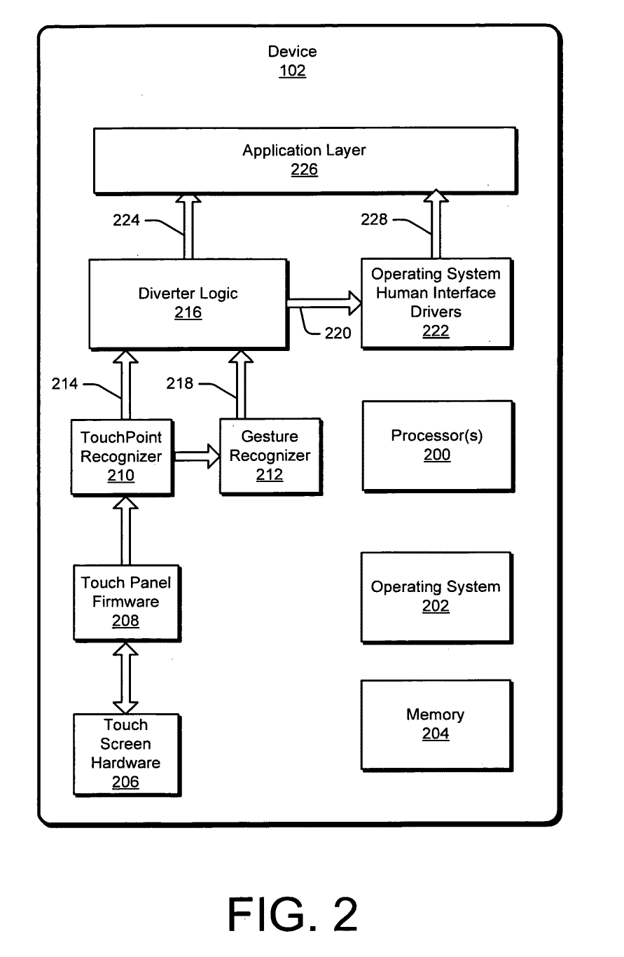

FIG. 2 shows an exemplary architecture of device 102. Device 102 can include one or more processors 200, an operating system or OS 202, and a memory 202 coupled to the processor(s) 200. Memory 204 can include various types of memory and/or memory devices, including but not limited to random access memory (RAM), read only memory (ROM), internal memory, and external memory. Furthermore, memory 204 can include computer readable instructions operable by device 102. It is to be understood that components described herein, may be integrated or included as part of memory 204.

Device 102 includes touch screen hardware 206. Touch screen hardware 206 includes the touch panel surfaces 104 and 106, and sensors and physical inputs that are part of touch panel surfaces 104 and 106. Touch screen hardware 206 provides for sensing of points that are activated on the touch panel surfaces 104 and 106. Touch panel firmware 208 can extract data from the physical sensors of the touch screen hardware 206. The extracted data is passed along as a stream of touch data, including image data. If no touch is made on at the touch screen hardware 206, no data is passed along.

The data (i.e., stream of data) is passed along to a touch point recognizer 210. The touch point recognizer 210 determines the shape of the touch, where the touch is performed and when it is performs. As discussed further below, the shape of the touch can determine the type of gesture that is implemented. The touch point recognizer 210 sends shape information to a gesture recognizer 212. The gesture recognizer 212 processes touch and shape information received from touch point recognizer 210, and determines a particular shape and gesture that may be associated with the shape. Gesture recognizer 212 can also determine shape change and position/position change of a shape.

Touch point recognizer 210, implementing for example a proprietary rich touch application program interface (API) 214, sends data to diverter logic 216. The gesture recognizer 212 can also send data to the diverter logic 216 through a proprietary gesture API 218. The diverter logic 216 can determine if the received content or data from the touch point recognizer 210 and the gesture recognizer 212 should be forwarded. For example, if the virtual keyboard 108 is active and running on the C surface 106, there is no need to send content or data, since the virtual keyboard 108 is consuming input from the C surface 106.

The diverter logic 216 can send data through a human interface driver(s) (HID) API 220, to operating system human interface drivers 222. The operating system human interface drivers 222 communicate with the OS 202. Since the touch point recognizer 210 and gesture recognizer 212 are separated from the OS 202, touch point gestures that are included in the OS 202 are not affected. For example, because gestures may be triggered by an action that is invisible to OS 202, events such as a change of window focus do not occur, permitting gestures to be made anywhere on the touch screen or C surface 106, and still affect an active (i.e., target) window. In addition different gestures can be added by updating the touch point recognizer 210 and gesture recognizer 212. The touch point recognizer 210 and gesture recognizer 212 can be considered as a gesture recognition engine.

The diverter logic 216 through a proprietary gesture and rich touch API 224, can provide data to an application layer 226. The operating system human interface drivers 222 can send data to the application layer 226, through an OS specific touch API 228. The application layer 226 processes received data (i.e., gesture data) accordingly with applications windows that are running on the device 102.

### Gesture Recognition

As discussed above, gesture recognizer 210 is implemented to recognize touch or shape data. The gesture recognizer 210 can be touch software, or a considered as a gesture recognition component of device 210, that processes touch data before and separate from the OS 200. Furthermore, touches can be classified by category, such as “Finger Touch”, “Blob”, and “Palm.” The gestures are distinguished from traditional finger touch based gestures, in that they are “shape” based as compared to “point” based. In certain implementations, only finger touch data may be sent to the OS 200, since finger touch data is “point” based. Shape based touches, such as “Blobs” and “Palm” can be excluded and not sent to the OS 200; however, the gesture recognizer 210 can receive all touch data. Once gestures are recognized, user feedback can be provided, indicating that gesture processing has begun, and hiding all touches from the OS 200, and gesture processing can begin. When gestures are completed (i.e., no more touches on the touch screen), normal processing can resume.

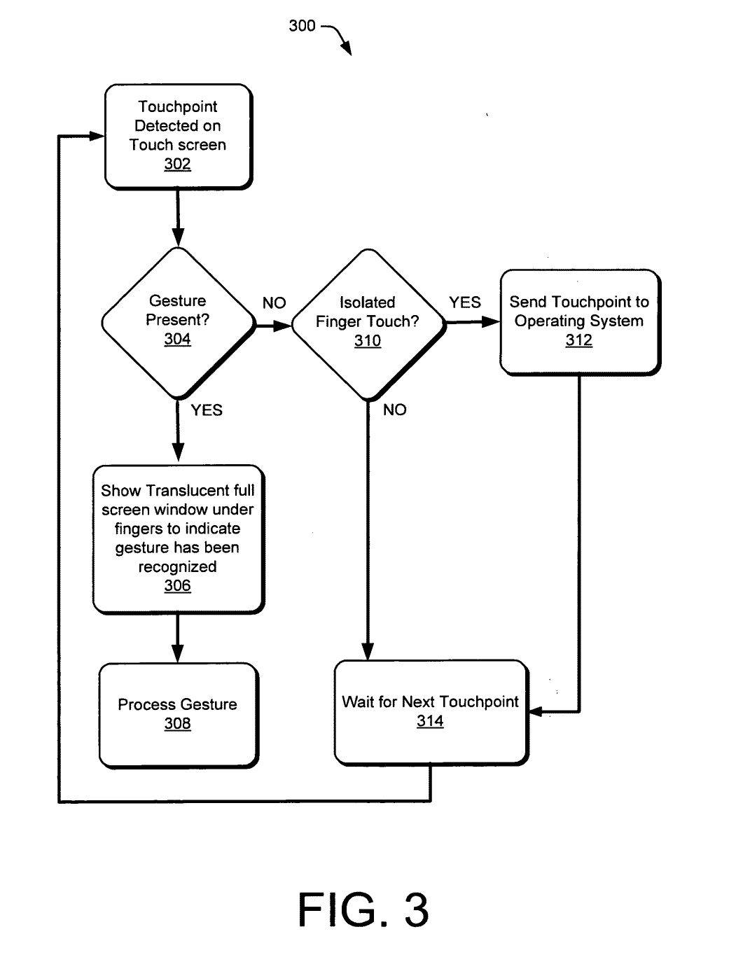

FIG. 3 is a flow chart for an example process 300 for gesture recognition and touch point redirection. Process 300 may be implemented as executable instructions by device 102. The order in which the method is described is not intended to be construed as a limitation, and any number of the described method blocks can be combined to implement the method, or alternate method. Additionally, individual blocks can be deleted from the method without departing from the spirit and scope of the subject matter described herein. Furthermore, the method can be implemented in any suitable hardware, software, firmware, or a combination thereof, without departing from the scope of the invention.

At block 302, detecting a touch point a touch screen is performed. The detecting may be performed on a C surface of device as described above, and processed as described above.

A determination is made as to the presence of a gesture (block 304), if the gesture is present, following the YES branch of block 304, at block 306, an indication can be provided that the gesture has been recognized. For example, a translucent full screen window may be shown under a user's fingers.

At block 308, processing of the gesture is performed. The processing may be performed as to the discussion above as to FIG. 2.

If the determination at block 304 is that a gesture is not present, following the NO branch of block 304, a determination can be made as to whether there is an isolated finger touch (block 310).

If there is an isolated finger touch, following the YES branch of block 310, at block 312, the touch point is sent to the operating system. At block 314, another touch point is waited for, and the process goes back to block 302.

If there is no isolated finger touch, following the NO branch of block 310, block 314 is performed, and another touch point is waited for.

### Exemplary Gestures

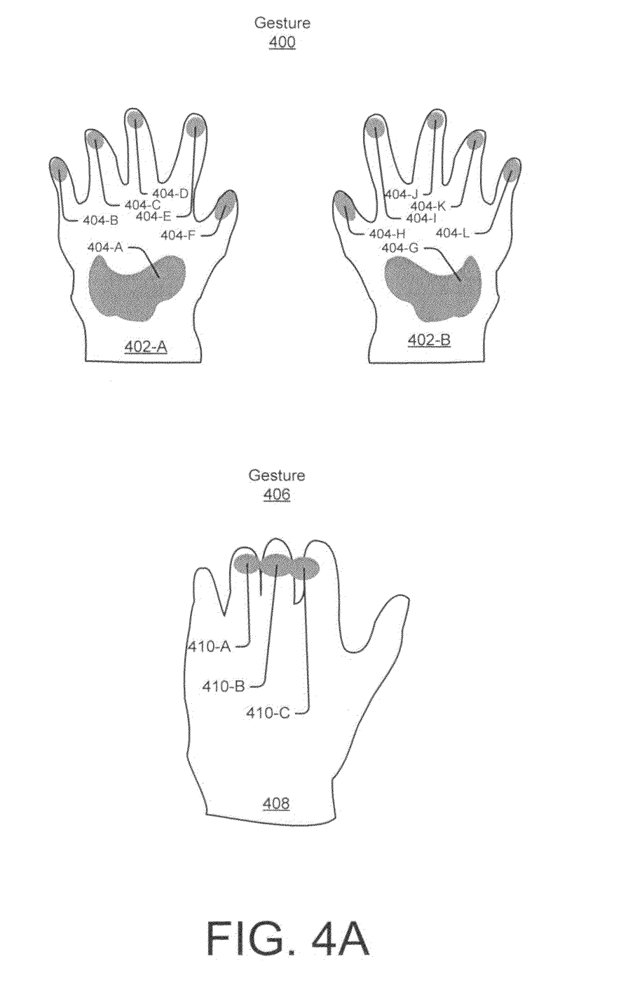

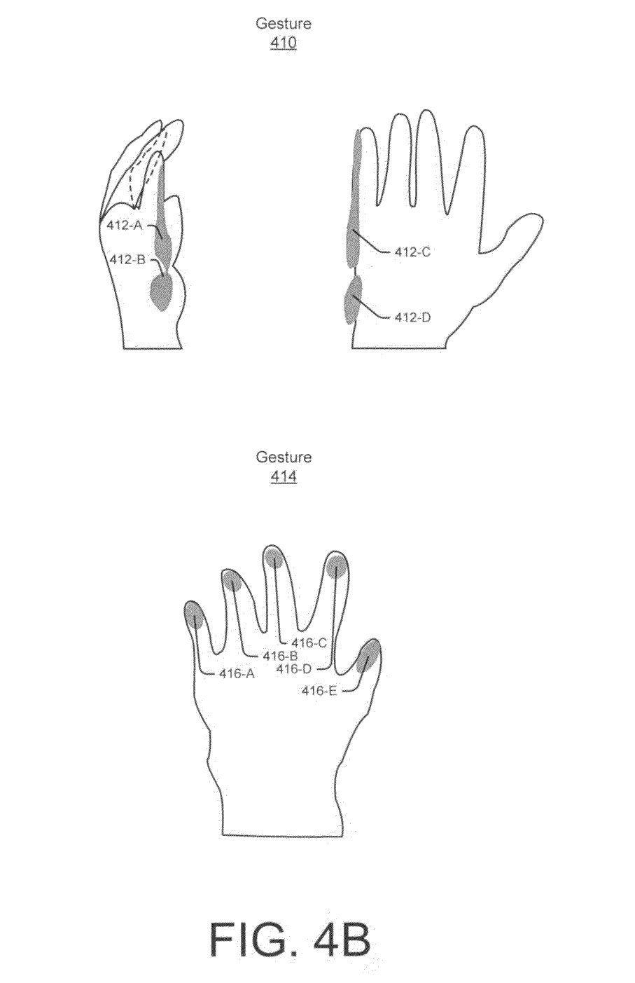

FIGS. 4A and 4B show example gestures. Four example gestures are described; however, it is contemplated that other gestures can also apply, and in particular shape based gestures. The four exemplary gestures are a) “Two hands down”, which may be used to activate the virtual keyboard 108; b) “Three Finger Tap”, which may be used to show a browser link on an opposite screen (i.e., B surface); c) “Sweep”, which may be used to quickly switch between active applications (windows); and d) “Grab”, which can be used to quickly move an active window around two screens.

As discussed above, since the operating system or OS 202 does not recognize the gesture, a number of gestures can be added or subtracted without having to update the operating system. In certain implementations, a gesture editor (e.g., touch point recognizer 210, gesture recognizer 212) may be provided allowing a user to create custom gestures. A single gesture motion in any area of a screen can initiate a desired action, which can be easier to do than touching specific areas. Once the action begins, less precision may be required to perform the action, since there is more room to perform maneuvers. For example, such gestures can be used to launch favorite applications; quickly lock the system; and implement other tasks. Examples of the gestures are described below.

Gesture 400 illustrates the “Two Hands Down” gesture. As discussed above, a dual screen device, such as device 102, may not have a physical keyboard. A virtual keyboard 108 can be used on the C Surface 106 touch screen, in place of a physical keyboard that may typically be provided the C-Surface. The “Two Hands Down” gesture provides for hands 402-A and 402-B to be placed on the touch screen, with contact points 404-A to 404-L actually touching the touch screen, the contact points 404 provided a recognizing shape associated with the “Two Hands Down” gesture. The “Two Hands Down” gesture can be used to quickly launch the virtual keyboard 108 on the device C-Surface 106.

Gesture 406 illustrates the “Three Finger Tap” gesture. The “Three Finger Tap” gesture provides for three fingers stuck together. The gesture involves a hand and actual touch points 410-A to 410-C. The touch processing classifies this action's set of touch points 410 as a mixture of “blobs” and/or touch points born from blobs, which is not seen (not recognized) by the operating system (e.g., OS 202). The action for the “Three Finger Tap” gesture can be used to open a tapped universal resource locator or URL, in a browser window on the opposite surface (e.g., B surface 104). In other words, if the tap occurred in a browser window on the C-Surface 106, a browser window can open on the B Surface 104, or if the tap was in a browser on the B-Surface 104 the URL will appear in a browser on the C Surface. This functionality/gesture can enable a unique internet browsing user model for a dual touch screen device, such as device 102.

Gesture 410 illustrates the “Sweep” gesture. The “Sweep” gesture provides for touch points 412-A and 412-B, or touch points 412-C and 412-D contacting the touch screen (e.g., C surface 106). The “Sweep” gesture involves the side of a hand (i.e., touch points 412) touching the touch screen, like a “karate chop.” An action that can be associated with the “Sweep” gesture can be to quickly switch between applications or applications. In most windowed operating systems such an action (i.e., switching between applications) is normally performed with keyboard shortcuts, but the virtual keyboard 108 may not always be present with a dual screen laptop, so this gesture allows quicker access to the function of switching between applications. In an exemplary operation, when “Sweep” gesture is first initiated a list of icons representing currently running applications can appear on the screen with a current active application highlighted. Sliding the sweep leftwards goes backwards in the list and rightwards goes forwards. When the hand is lifted off the surface of the touch screen, the currently selected application is activated.

Gesture 414 illustrates the “Grab” gesture. The “Grab” gesture provides for five touch points 416-A to 416-F contacting the touch screen, i.e., five fingers simultaneously placed on the touch screen. Unlike the other gestures described above, the “Grab” gesture includes non-blob touch points; however, the touch points are recognized as invisible to (i.e., not acknowledged by) the operating system (e.g., OS 202), because the touch point recognition software (e.g., touch point recognizer 208) does not provide the operating system (e.g., OS 202), touch points when there are more than three touch points on the screen. It should be noted that most users may not consistently place more than three fingers on the touch screen surface within a scan rate of the touch screen. In an exemplary operation, the “Grab” gesture can be used to quickly move an active window around the two screens (i.e., surfaces 104 and 106). After the “Grab” gesture is recognized, the user can lift all fingers, but one, from the surface, and move either up, down, left or right to cause actions to occur. For example, moving up can move the window to the B Surface 104; moving down can move the window to the C Surface 106; and moving left or right can begin a cyclical movement of the window on the current surface and then the opposite surface (e.g., first the window full screen is resized on the current screen, then the left/right half of the current screen, depending on direction, then the right/left half of the opposite surface, then full screen on the opposite surface then left/right half of opposite surface, then right/left half of starting surface, then the original placement of the window). The last action can allow the user to move windows quickly around the two display areas to common positions without having to use accurate touches to grab window edges or handles.

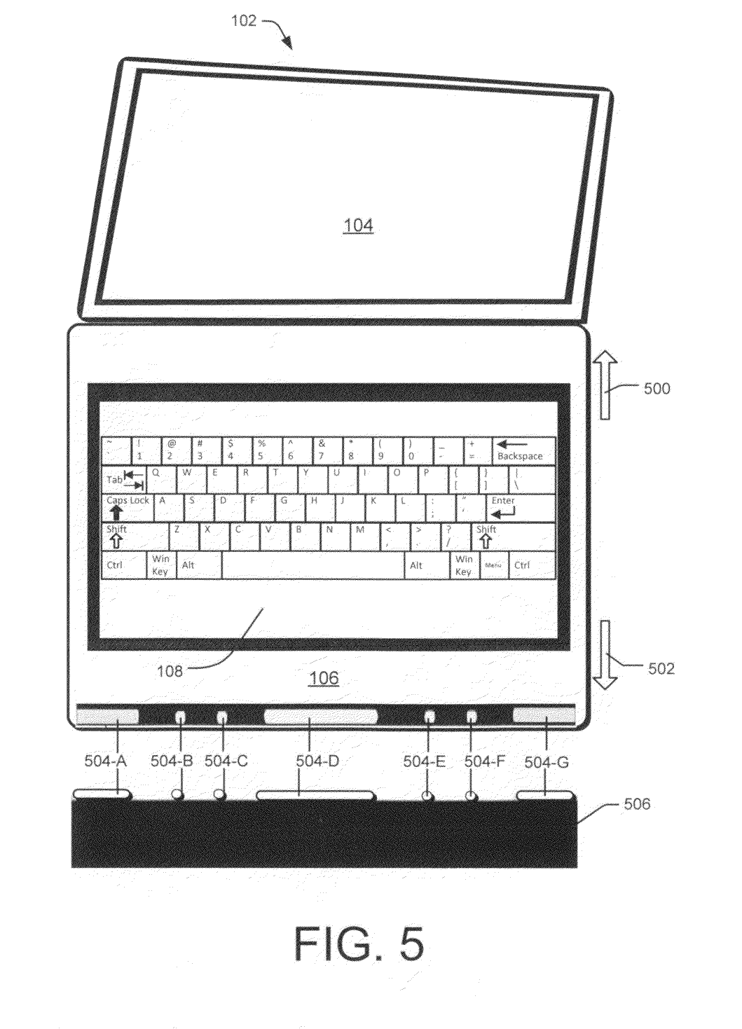

FIG. 5 illustrates the device 102 with the virtual keyboard 108 and tactile aids. As discussed above, the “Two Hands Down” gesture can be used to initiate the virtual keyboard 108 on the C surface 106. The virtual keyboard 108 can be hidden to save power or when additional screen space is desired by the user. As discussed above and further below, gestures and methods can be provided to allow the user to intuitively restore a hidden virtual keyboard 108, dynamically place the virtual keyboard 108 for typing comfort, and manage other windows on screen to make the virtual keyboard 108 more usable. Window management may be necessary, because when the virtual keyboard 108 is restored, it may obscure content that was previously shown where the virtual keyboard 108 is displayed. Physical or tactile aids can be placed on the device 102 to assist touch typists in determining where keys are without looking at the virtual keyboard 108. The physical aids provide a tactile feedback to the user as to the position of their hands, and use “muscle memory” to reduce the need to look down at the keyboard while typing.

As discussed above and discussed in greater detail below, the following concepts can be implemented. The touch gestures as described above can be used to hide and restore the virtual keyboard 108, including logic to dynamically place the keyboard on the touch screen surface where the user desires. Physical or tactile aids can be included in the industrial or physical design of lower surface of the laptop to provide feedback to the user of the position of their hands relative to the touch screen. Logic can be provided that dynamically moves windows or applications that would otherwise be obscured when the virtual keyboard is restored on to the lower surface, so that users can see where they are typing input.

As described above, the “Two Hands Down” gesture can be used to initiate and call up the virtual keyboard 108. After the “Two Hands Down” gesture is initiated, the virtual keyboard 108 appears on the C surface 106. In certain implementations, the virtual keyboard 108 that appears on the C Surface 106 fills the width of the screen or C surface 106, but does not take up the entire screen (C Surface 106). This permits the keyboard to be moved up 500 and down 502 on the C surface 106, as the user desires.

For example, when the keyboard or “Two Hands Down” gesture is detected, the virtual keyboard 108 can be positioned vertically on the C surface 106 with the home row (i.e., row containing “F” and “H” characters) placed under the middle fingers (in the other implementations, the index fingers are detected) of the two hands. When the virtual keyboard 108 first appears it can be disabled, because a keyboard rest may be. Therefore no keystrokes are typed, even though fingers may be touching the screen or C surface 106 at this time. The virtual keyboard 108 position is set, and user can begin typing. To hide the virtual keyboard 108, a gesture such as the “Sweep” gesture can be implemented. In other implementations, the virtual keyboard 108 can hide automatically, if there are no touches on the screen for a user defined timeout period.

Because a touch screen is smooth, users do not have the tactile feedback that a physical keyboard provides to help type keys without looking at the keys, which is used in touch-typing. To help the user determine where their fingers are horizontally on the screen, tactile or physical aides can placed on the casing of the device 102 (e.g., front edge of a notebook or laptop computer), to give the user feedback as to where their wrists/palms are along the C Surface 106 of the device 102. The exemplary tactile aids include a left edge indicator 504-A, a left bump #1 indicator 504-B, a left bump #2 indicator 504-C, a center rise indicator 504-D, a right bump #1 indicator 504-E, a right bump #2 indicator 504-F, and a right edge indicator 504-G. A front edge view of device 102 is illustrated by 506.

The virtual keyboard 108 hand placement (tactile aids) or indicators 504 can provide for raised textures along the front edge 506 of the case of the device 102, where the user's wrists or palms would normally rest when they type on the virtual keyboard 108. The raised texture should high enough for the user to feel, but not so high that the bumps would discomfort the user. Exemplary heights of the indicators can be in the range of 1/32″ to 3/32″. The indicators 504 can be placed, so that the user will always feel at least one of the indicators if they place their wrists or palms on the front edge of the device 102. With these indicators 505, the user can always get feedback as to the position of their hands along the front edge of the device. When combined with the automatic vertical positioning (as described below) of the virtual keyboard 108, the indicators 504 permit users to feel where their hands need to be placed in order to type comfortably. As a user uses the device 102 more often, the user will be able to feel the indicators 504 on their wrists/palms, and be able to map finger position relative to the indicators 504. Eventually they can rely on muscle memory for finger position relative to the keys, reducing the need to look at the keyboard to confirm typing.

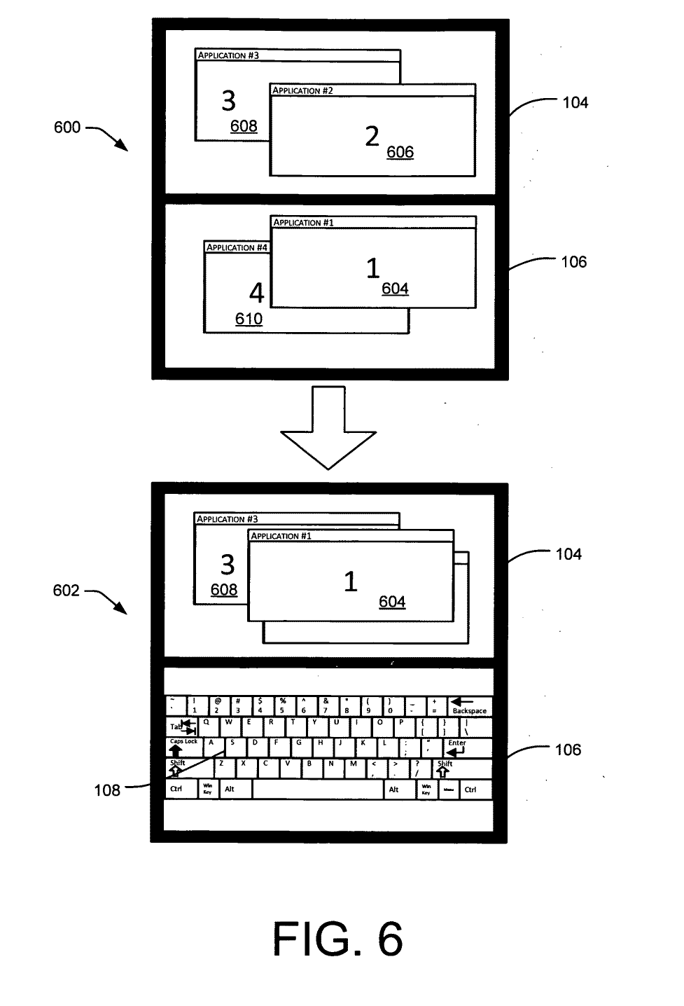

FIG. 6 illustrates anticipatory window placement with the implementation of virtual keyboard 108. In this example, described is an illustrative dual screen device (e.g., device 102) that calls up multiple windows/applications and a virtual keyboard. The B surface 104 and C surface 106 go from displaying a configuration 600 to displaying a configuration 602. In configuration 600, applications or windows “2” 602 and “3” 604 are displayed on B surface 104 and windows “1” and “4” are displayed on C surface 106. In configuration 602, the virtual keyboard 108 is called and initiated on C surface 106, and the windows “1” 604, “2” 606, “3” 608, and “4” 610 are moved to B surface 104.

When the virtual keyboard appears 108 on the C surface 106, it covers the entire screen so that screen is no longer useful for viewing application windows. More importantly if the active application (window), such as window “1” 604 or window “4” 610, for virtual keyboard 108 input was on the C surface 106, the user could no longer see the characters from keystrokes appear as they type. In anticipation of this, when the virtual keyboard 108 appears, windows on the C-Surface to the B-Surface screen are moved so that they can be seen by the user. This window movement does not change the display order or Z-order, in which a window is visible relative to other windows. In this example the windows 604, 606, 608 and 610 are numbered in their display order or Z-order. That is, if all the windows were placed on the same upper left co-ordinate, window “1” 604 would be on top; window “2” 606 below window “1” 604; window “3” 608 below window “2” 606; and window “4” 610 on the bottom.

In this example, in configuration 600, the active application window is window “1” 60. This window would be the window that accepts keyboard input. When the virtual keyboard is activated (configuration 602), window “1” 604 and window “4” 610 would be moved to the same relative co-ordinates on the B-Surface 106 screen. It is to be noted that certain operating systems support “minimizing” application windows to free up screen space without shutting down an application, and permitting a window to be “restored” to its previous state. In this example, if window “4” 610 was minimized before the virtual keyboard 108 was activated, and then restored while the virtual keyboard 108 was active, window “4” 610 would be hidden by the keyboard. This method addresses such a condition, and provides that if a window on the C surface 106 was minimized, and the virtual keyboard 108 was subsequently activated, the window would be restored to the B surface 104, if the user activates that window while the virtual keyboard 108 is active.

Configuration 602 illustrates the window positions after being moved. Window “4” 610 no longer visible because it is hidden by window “3” 608. Window “1” 604 is now on top of window “2” 606, because window “1” 604 was the active window. When the virtual keyboard 108 is hidden, all moved windows are returned to their original screen (i.e., configuration 600). If the windows (e.g., windows “1” 604 and “4” 610) were moved while on the B surface 104, they will be moved to the same relative position on the C Surface 106.

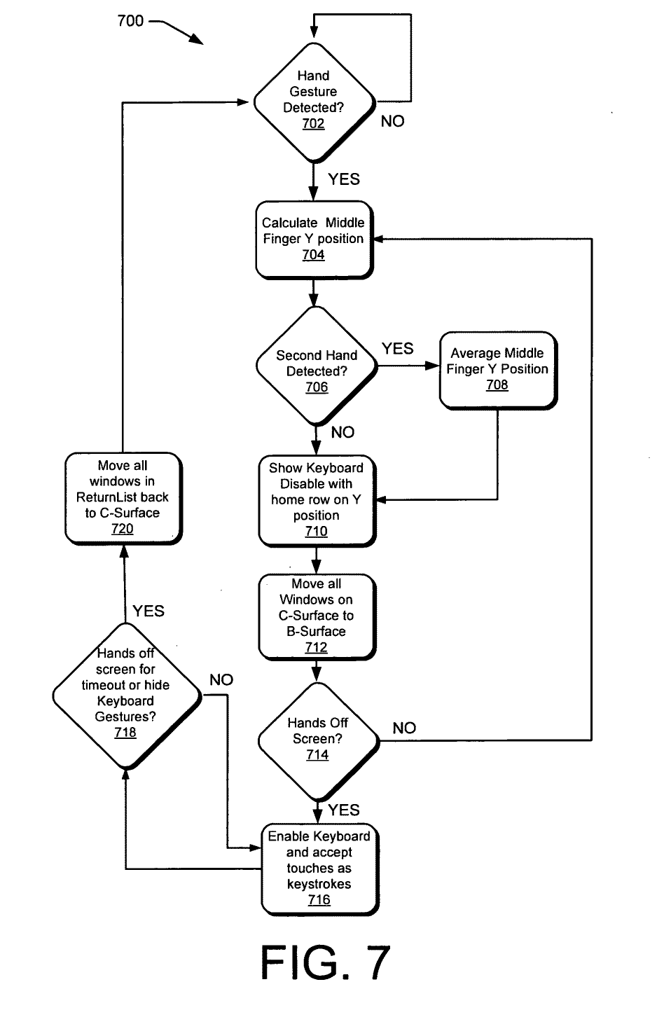

FIG. 7 is a flow chart for an example process 700 for calling up a virtual keyboard and positioning windows. Process 700 may be implemented as executable instructions performed by device 102. The order in which the method is described is not intended to be construed as a limitation, and any number of the described method blocks can be combined to implement the method, or alternate method. Additionally, individual blocks can be deleted from the method without departing from the spirit and scope of the subject matter described herein. Furthermore, the method can be implemented in any suitable hardware, software, firmware, or a combination thereof, without departing from the scope of the invention.

A determination is made as to whether a hand gesture is detected. If a hand gesture is not detected, following the NO branch of block 702, determination is made until a hand gesture is detected. If a hand gesture is detected, following the YES branch of block 702, then block 704 is performed.

At block 704, calculation is made as to the position of a finger. In this example the finger is the middle finger; however, other fingers (i.e., index finger) can be used. In particular, the “Y” position of the middle finger is detected.

A determination is made if a second hand gesture is detected. If a second hand gesture is detected, following the YES branch of block 706, then block 708 is performed.

At block 708, averaging is performed of the Y position of the finger of the first hand gesture and the Y position of the finger of the second hand gesture.

If a second hand gesture is not recognized, following the NO branch of block 706, or after performing block 708, block 710 is performed.

At block 710, the virtual keyboard (e.g., virtual keyboard 108) is shown to be disabled with the home row (i.e., row with the “J” and “K” keys) on the Y finger position of either the one hand gesture or the average Y finger positions of the two hand gestures.

At block 712, windows or applications that are running on one surface, i.e., the C surface, are moved to the other surface, i.e., the B surface, as the virtual keyboard is initiated (called up).

A determination is made if a user's hands have been taken off the screen. If it is determined that the hands are not off the screen, following the NO branch of block 714, then block 704 is performed. If it is determined that hands are off the screen, following the YES branch of block 714, the block 716 is performed.

At block 716, enabling of the virtual keyboard (e.g. virtual keyboard 108) is performed, allowing and accepting touches and keystrokes to the virtual keyboard.

A determination is made as to whether the user has had their hands off the screen after a predetermined timeout period, or whether a keyboard gesture (e.g., the “Sweep” gesture) is performed, that puts to sleep or deactivates the virtual keyboard. If such a timeout or gesture is not determined, following the NO branch of block 718, the block 716 is continued to be performed. If such a determination is made, following the YES branch of block 716, then block 720 is performed.

At block 720, placing or moving all windows or applications based on a “Return List” is performed. In particular, windows or applications that were on the C surface prior to the virtual keyboard being initiated (called) are returned to their previous positions on the C surface.

### CONCLUSION

Although specific details of illustrative methods are described with regard to the figures and other flow diagrams presented herein, it should be understood that certain acts shown in the figures need not be performed in the order described, and may be modified, and/or may be omitted entirely, depending on the circumstances. As described in this application, modules and engines may be implemented using software, hardware, firmware, or a combination of these. Moreover, the acts and methods described may be implemented by a computer, processor or other computing device based on instructions stored on memory, the memory comprising one or more computer-readable storage media (CRSM).

The CRSM may be any available physical media accessible by a computing device to implement the instructions stored thereon. CRSM may include, but is not limited to, random access memory (RAM), read-only memory (ROM), electrically erasable programmable read-only memory (EEPROM), flash memory or other solid-state memory technology, compact disk read-only memory (CD-ROM), digital versatile disks (DVD) or other optical disk storage, magnetic disk storage or other magnetic storage devices, or any other medium which can be used to store the desired information and which can be accessed by a computing device.

What is claimed is:

1. A method implemented by a dual screen device for operating system independent gestures, comprising:
detecting a touch point at one screen of the dual screen device;
determining the presence of a operating system independent gesture; and
initiating an action association with the operating system independent gesture.

2. The method of claim 1, wherein the detecting differentiates between finger based and shape based touches.

3. The method of claim 1, wherein the determining presence of the operating system independent gesture includes indicating to a user that the gesture is recognized.

4. The method of claim 3, wherein the indicating to a user that the gesture is recognized, initiates and places a virtual key board on the one screen of the dual screen device.

5. The method of claim 1 further comprising initiating a virtual keyboard that appears on the one screen.

6. The method of claim 5 further comprising placing applications present on the one screen to a second screen of the dual screen device, when the virtual keyboard appears.

7. The method of claim 1 further comprising providing for different user defined operating system independent gestures.

8. A dual screen device comprising:
one or more processors;
memory coupled to the processors;
a touch point recognizer that determines touch and shape information at one screen of the dual screen device.
a gesture recognizer that processes the touch and shape information, and determines a particular shape and associates the particular shape to an operating system independent gesture.

9. The dual screen device of claim 8, wherein touch point recognizer and gesture and gesture recognizer are part of a gesture engine that provides for customized operating system independent gestures.

10. The dual screen device of claim 8, wherein a virtual keyboard is initiated when the gesture recognizer recognizes a gesture associated with the virtual key board.

11. The dual screen device of claim 10, wherein one or more windows are moved from a first screen where the virtual keyboard appears to a second screen of the dual screen device.

12. The dual screen device of claim 10, wherein the virtual keyboard is centered on a first screen of the dual screen device, based on the gesture that is recognized.

13. The dual screen device of claim 10 further comprising tactile aides placed on the physical casing of the dual screen device.

14. The dual screen device of claim 13 wherein the tactile aides include one or more of the following on the front edge of the dual screen device: a left edge indicator, a left bump indicator, a center rise indicator, a right bump indicator, and right edge indicator.

15. The dual screen device of claim 1 further comprising diverter logic than sends operating system controlled touch information to an operating system.

16. A method of initiating a virtual key and moving windows in a dual screen device, comprising:
determining a keyboard based gesture associated with the virtual keyboard from multiple point and shape based gestures;
moving the windows from a first screen to a second screen of the dual screen device;
initiating the virtual keyboard on the first screen; and
centering the virtual keyboard based on touch positions related to the keyboard based gesture.

17. The method of claim 16, wherein the determining the keyboard gesture is based on a two hands down gesture on the first screen.

18. The method of claim 16, wherein the moving the windows includes redisplaying the windows on the first screen, when the virtual keyboard is deactivated, the moving and redisplaying based on a Z-order of the windows relative to one another.

19. The method of claim 16, wherein the centering is based on finger positions and home row of the virtual keyboard.

20. The method of claim 16 further recognizing and differentiating one or more of the following shape based gestures: two hands down, three finger tap, sweep, and grab.
